(19) United States
(12) Patent Application Publication
(10) Pub. No.: US 2026/0178309 A1
(43) Pub. Date: Jun. 25, 2026

(54) UPDATE MANAGEMENT APPARATUS, VEHICLE-MOUNTED SYSTEM, CONTROL METHOD, AND COMPUTER PROGRAM

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventors: Makoto MOTOYAMA, Yokkaichi-shi, Mie (JP); Shota USHIRO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 19/124,709

(22) PCT Filed: Oct. 12, 2023
(86) PCT No.: PCT/JP2023/037040

§ 371 Date: Apr. 25, 2025

(30) Foreign Application Priority Data
Oct. 28, 2022 (JP) 2022-173192

(51) Int. Cl. G06F 8/65; G06F 8/658; G06F 8/71

(52) U.S. Cl. CPC G06F 8/65; G06F 8/658; G06F 8/71

(57) ABSTRACT

An update management apparatus includes a receiver unit, a determining unit, and a transmitter unit. The receiver unit receives, from an external apparatus, first update data for updating software of a first vehicle-mounted apparatus that operates in a first power supplying state and a second power supplying state, and second update data for updating software of a second vehicle-mounted apparatus that operates in the second power supplying state. The determining unit determines whether the power supplying state is the first or the second power supplying state. The transmitter unit transmits the first update data to the first vehicle-mounted apparatus when the determining unit determines that the power supplying state of the vehicle is the first power supplying state and transmits the second update data to the second vehicle-mounted apparatus when the determining unit determines that the power supplying state of the vehicle is the second power supplying state.

### CROSS-REFERENCE TO RELATED APPLICATIONS

This application is the U.S. national stage of PCT/JP2023/037040 filed on Oct. 12, 2023, which claims priority of Japanese Patent Application No. JP 2022-173192 filed on Oct. 28, 2022, the contents of which are incorporated herein.

### TECHNICAL FIELD

The present disclosure relates to an update management apparatus, a vehicle-mounted system, a control method, and a computer program.

### BACKGROUND

Vehicle-mounted apparatuses, which are installed in a vehicle and are connected to a plurality of ECUs (Electronic Control Units), are known. In recent years, the power sources provided in vehicles have become more complex, and the power supplying states of such sources have become increasingly diverse. As vehicle control has become more diverse, including systems such as parking assistance, it has become increasingly common for the software installed in an ECU to be updated.

JP 2020-032201A discloses a central gateway (or “CGW”) to which a plurality of ECUs are connected. The CGW in JP 2020-032201A monitors the power supplying state, and during the updating and activation of the software of an ECU, has a power management ECU that manages a power supply maintain the power supplying state.

When updating and activating software of an ECU, the power supplying state of the vehicle must be a state in which the updated ECU can operate. For this reason, the updating and activation of an ECU will commence after entering the power supplying state required by that ECU. In particular, if ECUs to be updated become operational after a key switch that places a vehicle in a drivable state has been set in a drivable position, there is the risk that it will take a longer time before the vehicle becomes drivable.

### SUMMARY

An update management apparatus according to an aspect of the present disclosure is an update management apparatus that manages a software update of a vehicle-mounted apparatus in a vehicle with a plurality of power supplying states, the update management apparatus including: a receiver unit configured to receive, from an external apparatus outside the vehicle, first update data for updating software of a first vehicle-mounted apparatus that operates in the first power supplying state and the second power supplying state that differs from the first power supplying state, and second update data for updating software of a second vehicle-mounted apparatus that does not operate in the first power supplying state but operates in the second power supplying state; a determining unit configured to determine whether a power supplying state of the vehicle is the first power supplying state or the second power supplying state; and a transmitter unit configured to transmit the first update data to the first vehicle-mounted apparatus when the determining unit has determined that the power supplying state of the vehicle is the first power supplying state and transmitting the second update data to the second vehicle-mounted apparatus when the determining unit has determined that the power supplying state of the vehicle is the second power supplying state.

A control method according to an aspect of the present disclosure is a control method of an update management apparatus that manages a software update of a vehicle-mounted apparatus in a vehicle with a plurality of power supplying states, the plurality of power supplying states including a first power supplying state and a second power supplying state that differs from the first power supplying state, the control method including: a step of receiving, from an external apparatus outside the vehicle, first update data for updating software of a first vehicle-mounted apparatus that operates in the first power supplying state and the second power supplying state, and second update data for updating software of a second vehicle-mounted apparatus that does not operate in the first power supplying state but operates in the second power supplying state; a step of determining whether a power supplying state of the vehicle is the first power supplying state or the second power supplying state; a first step of transmitting the first update data to the first vehicle-mounted apparatus when the step of determining has determined that the power supplying state of the vehicle is the first power supplying state; and a second step of transmitting the second update data to the second vehicle-mounted apparatus when the step of determining has determined that the power supplying state of the vehicle is the second power supplying state.

A computer program according to an aspect of the present disclosure is a computer program for controlling an update management apparatus that manages a software update of a vehicle-mounted apparatus in a vehicle with a plurality of power supplying states, the plurality of power supplying states including a first power supplying state and a second power supplying state that differs from the first power supplying state, the computer program including: a step of receiving, from an external apparatus outside the vehicle, first update data for updating software of a first vehicle-mounted apparatus that operates in the first power supplying state and the second power supplying state, and second update data for updating software of a second vehicle-mounted apparatus that does not operate in the first power supplying state but operates in the second power supplying state; a step of determining whether a power supplying state of the vehicle is the first power supplying state or the second power supplying state; a first step of transmitting the first update data to the first vehicle-mounted apparatus when the step of determining has determined that the power supplying state of the vehicle is the first power supplying state; and a second step of transmitting the second update data to the second vehicle-mounted apparatus when the step of determining has determined that the power supplying state of the vehicle is the second power supplying state.

### Advantageous Effects

According to the present disclosure, it is possible to provide an update management apparatus that reduces waiting time related to the updating and activation of software.

### BRIEF DESCRIPTION OF DRAWINGS

FIG. 1 is a block diagram depicting one example of a vehicle-mounted system according to a first embodiment.

FIG. 2 is a block diagram depicting one example of the internal configuration of an update management ECU according to the first embodiment.

FIG. 3 is a block diagram depicting one example of the internal configuration of an ECU according to the first embodiment.

FIG. 4 is a functional block diagram of an update management ECU according to the first embodiment.

FIG. 5 is a table depicting one example of an ECU table in which ECUs are listed.

FIG. 6 is a table depicting one example of an ECU table in which ECUs are listed.

FIG. 7 is a flowchart depicting a control method according to the first embodiment.

FIG. 8 is a sequence diagram of a vehicle-mounted system according to the first embodiment.

FIG. 9 is a sequence diagram of a vehicle-mounted system according to the first embodiment.

FIG. 10 is a flowchart of a control method according to a second embodiment when a retrofitted ECU has been detected.

### DETAILED DESCRIPTION OF PREFERRED EMBODIMENTS

Several embodiments of the present disclosure will first be listed and described in outline.

In a first aspect, an update management apparatus according to the present disclosure is an update management apparatus for managing a software update of a vehicle-mounted apparatus in a vehicle with a plurality of power supplying states, the update management apparatus including: a receiver unit configured to receive, from an external apparatus outside the vehicle, first update data for updating software of a first vehicle-mounted apparatus that operates in a first power supplying state and a second power supplying state that differs from the first supplying state, and second update data for updating software of a second vehicle-mounted apparatus that does not operate in the first power supplying state but operates in the second power supplying state; a determining unit configured to determine whether a power supplying state of the vehicle is the first power supplying state or the second power supplying state; and a transmitter unit configured to transmit the first update data to the first vehicle-mounted apparatus when the determining unit has determined that the power supplying state of the vehicle is the first power supplying state and transmitting the second update data to the second vehicle-mounted apparatus when the determining unit has determined that the power supplying state of the vehicle is the second power supplying state.

In keeping with the power supplying state of the vehicle, the update management apparatus sends update data to vehicle-mounted apparatuses whose software can be updated in that power supplying state. By doing so, the software of the vehicle-mounted apparatuses is sequentially updated at appropriate times in keeping with the power supplying state, which shortens the time taken for the vehicle to become drivable.

In a second aspect, the receiver unit may receive the first update data and the second update data from the external apparatus while the power supplying state is the first power supplying state.

With this configuration, the update management apparatus can receive the update data from the external apparatus in advance. By doing so, the update data is downloaded earlier, which shortens the time taken for the vehicle to become drivable.

In a third aspect, the update management apparatus may further include an activating unit configured to activate, when the determining unit has determined that the power supplying state is the first state, software that was updated using the first update data at the first vehicle-mounted apparatus that executes a predetermined first function without the second vehicle-mounted apparatus, and activate, when the determining unit has determined that the power supplying state is the second state, software that was updated using the first update data and the second update data at the first vehicle-mounted apparatus and the second vehicle-mounted apparatus that execute a predetermined second function executed by the first vehicle-mounted apparatus and the second vehicle-mounted apparatus.

The update management apparatus activates software at a group of vehicle-mounted apparatuses in the power supplying state in which that group of vehicle-mounted apparatuses execute a predetermined function. The group of vehicle-mounted apparatuses, which includes vehicle-mounted apparatuses that operate in different power supplying states, can execute the predetermined function with no discrepancies.

In a fourth aspect, the update management apparatus may be configured so that when a third vehicle-mounted apparatus has been newly connected to the update management apparatus to which the first vehicle-mounted apparatus and the second vehicle-mounted apparatus are connected, the receiver unit receives third update data for updating software of the third vehicle-mounted apparatus from an external apparatus outside the vehicle, the transmitter unit transmits, when the third vehicle-mounted apparatus operates in the first power supplying state and the second power supplying state and the determining unit has determined that the power supplying state of the vehicle is the first power supplying state, the third update data to the third vehicle-mounted apparatus, and the transmitter unit transmits, when the third vehicle-mounted apparatus does not operate in the first power supplying state but operates in the second power supplying state and the determining unit has determined that the power supplying state of the vehicle is the second power supplying state, the third update data to the third vehicle-mounted apparatus.

When a new third vehicle-mounted apparatus is connected to the update management apparatus, the third update data is transmitted to the third vehicle-mounted apparatus in a power supplying state in which the third vehicle-mounted apparatus can operate, which enables the newly added third vehicle-mounted apparatus to be updated at appropriate timing.

In a fifth aspect, the receiver unit may receive the first update data, the second update data, and the third update data from the external apparatus while the power supplying state is the first power supplying state.

With this configuration, since the third update data is downloaded to the update management apparatus in the first power supplying state, when for example, the third vehicle-mounted apparatus does not operate in the first power supplying state but operates in the second power supplying state, there is no need to download the third update data after a switch to the second power supplying state, which means that the third vehicle-mounted apparatus can be updated efficiently.

In a sixth aspect, the activating unit may activate, when the third vehicle-mounted apparatus operates in the first power supplying state and the second power supplying state and the determining unit has determined that the power supplying state is the first state, software that was updated using the third update data at the third vehicle-mounted apparatus that executes a predetermined third function with the first vehicle-mounted apparatus without the second vehicle-mounted apparatus, and may activate software that was updated using the first update data at the first vehicle-mounted apparatus that executes the third function, may activate, when the third vehicle-mounted apparatus does not operate in the first power supplying state but operates in the second power supplying state and the determining unit has determined that the power supplying state is the second state, software that was updated using the third update data at the third vehicle-mounted apparatus that executes a predetermined fourth function with the second vehicle-mounted apparatus, and may activate software that was updated using the second update data at the second vehicle-mounted apparatus that executes the fourth function.

With this configuration, even when a new vehicle-mounted apparatus is connected, the update management apparatus activates the group of vehicle-mounted apparatuses that execute a predetermined function in a power supplying state in which that group of vehicle-mounted apparatuses operates. By doing so, even when a new vehicle-mounted apparatus has been connected, a group of vehicle-mounted apparatuses including vehicle-mounted apparatuses that operate in different power supplying states can execute the predetermined function with no discrepancies.

In a seventh aspect, the first power supplying state may be a power supplying state when the vehicle is in a state where the vehicle is incapable of running, and the second power supplying state may be a power supplying state when the vehicle is in a state where the vehicle is capable of running.

With this configuration, the update management apparatus causes vehicle-mounted apparatuses capable of updating their software while the power supplying state is in a state where the vehicle cannot be driven to perform an update in that state. On the other hand, for vehicle-mounted apparatuses that cannot update their software unless the power supplying state is a state where the vehicle can be driven, the update management apparatus causes the vehicle-mounted apparatuses to update their software when the vehicle has become capable of being driven. By doing so, the time taken for the vehicle to become drivable is shortened. A group of vehicle-mounted apparatuses that execute a predetermined function can execute that predetermined function with no discrepancies.

In an eighth aspect, a vehicle-mounted system according to an aspect of the present disclosure includes: the update management apparatus according to the first through the seventh aspects; and the first vehicle-mounted apparatus, the second vehicle-mounted apparatus, or the third vehicle-mounted apparatus connected to the update management apparatus.

In a ninth aspect, a control method according to an aspect of the present disclosure is a control method of an update management apparatus that manages a software update of a vehicle-mounted apparatus in a vehicle with a plurality of power supplying states, the control method including: a step of receiving, from an external apparatus outside the vehicle, first update data for updating software of a first vehicle-mounted apparatus that operates in a first power supplying state and a second power supplying state that differs from the first power supplying state, and second update data for updating software of a second vehicle-mounted apparatus that does not operate in the first power supplying state but operates in the second power supplying state; a step of determining whether a power supplying state of the vehicle is the first power supplying state or the second power supplying state; a first step of transmitting the first update data to the first vehicle-mounted apparatus when the step of determining has determined that the power supplying state of the vehicle is the first power supplying state; and a second step of transmitting the second update data to the second vehicle-mounted apparatus when the step of determining has determined that the power supplying state of the vehicle is the second power supplying state.

In keeping with the power supplying state of a vehicle, the update management apparatus sends update data to vehicle-mounted apparatuses whose software can be updated in that power supplying state. By doing so, the software of the vehicle-mounted apparatuses is sequentially updated at appropriate times in keeping with the power supplying state, which shortens the time taken for the vehicle to become drivable.

In a tenth aspect, a computer program according to an aspect of the present disclosure is a computer program for controlling an update management apparatus that manages a software update of a vehicle-mounted apparatus in a vehicle with a plurality of power supplying states, the computer program including: a step of receiving, from an external apparatus outside the vehicle, first update data for updating software of a first vehicle-mounted apparatus that operates in a first power supplying state and a second power supplying state that differs from the first power supplying state, and second update data for updating software of a second vehicle-mounted apparatus that does not operate in the first power supplying state but operates in the second power supplying state; a step of determining whether a power supplying state of the vehicle is the first power supplying state or the second power supplying state; a first step of transmitting the first update data to the first vehicle-mounted apparatus when the step of determining has determined that the power supplying state of the vehicle is the first power supplying state; and a second step of transmitting the second update data to the second vehicle-mounted apparatus when the step of determining has determined that the power supplying state of the vehicle is the second power supplying state.

In keeping with the power supplying state of the vehicle, the update management apparatus sends update data to vehicle-mounted apparatuses whose software can be updated in that power supplying state. By doing so, the software of the vehicle-mounted apparatuses is sequentially updated at appropriate times in keeping with the power supplying state, which shortens the time taken for the vehicle to become drivable.

### First Embodiment

A first embodiment of the present disclosure will now be described in detail with reference to the accompanying drawings.

### Configuration of Vehicle-Mounted System

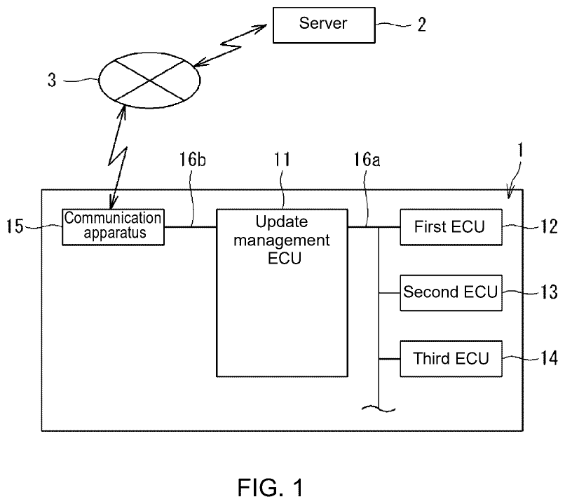

FIG. 1 is a diagram depicting an example configuration of a vehicle-mounted system 1 according to the first embodiment.

The vehicle-mounted system 1 is a system mounted in a vehicle, such as an automobile. The vehicle-mounted system 1 includes an update management ECU 11, a first ECU 12, a second ECU 13, a third ECU 14, communication buses 16a and 16b, and a communication apparatus 15.

The update management ECU 11 (where ECU means “Electronic Control Unit”) is an update management apparatus that manages software updates of vehicle-mounted apparatuses in a vehicle that has a plurality of power supplying states. The plurality of power supplying states include at least a first power supplying state and a second power supplying state. As examples, the first power supplying state is a power supplying state where the vehicle is not capable of running, and the second power supplying state is a power supplying state when the vehicle is capable of running.

As one example, the first power supplying state is a power supplying state when a key switch, which starts the engine when a key is inserted, is in the OFF position. As a specific example, the first power supplying state is a state where power is not supplied from the battery of the vehicle to the majority of electrical devices in the vehicle and power is directly supplied to only the minimum necessary vehicle-mounted apparatuses. Examples of such low number of electrical devices include a security system and a clock. Hereinafter, the first power supplying state is referred to as the “+B state”.

As one example, the second power supplying state is a power supplying state where the key switch for starting the engine is in the ignition position. As a specific example, one example of the second power supplying state is a state where power is supplied to every electrical device and where the vehicle will start moving when the accelerator is depressed. Hereinafter, the second power supplying state is referred hereinafter to as the “IG state”.

Note that although two power supplying states of a vehicle will be described, that is, the first power supplying state and the second power supplying state, the power supplying states are not limited to such and may be further subdivided. The following description may also refer to vehicle-mounted apparatuses as “ECUs”.

The update management ECU 11 manages software updates for vehicle-mounted apparatuses in a vehicle with a plurality of power supplying states. To do so, the update management ECU 11 is configured to operate in power supplying states in which software updates are performed. As one example, the update management ECU 11 is capable of operating in the +B state and the IG state.

As one example, the update management ECU 11 functions as an integrated ECU that manages the first ECU 12, the second ECU 13, and the third ECU 14. As one example, the update management ECU 11 may transmit update data downloaded from a server 2, which is an external apparatus that is outside the vehicle and is connected via a network 3, to the first ECU 12, the second ECU 13, and the third ECU 14.

The update management ECU 11 may function as a GW-ECU (Gateway-ECU) that relays data transmitted and received between the communication apparatus 15 and the first ECU 12, the second ECU 13, and the third ECU 14. The internal configuration of the update management ECU 11 will be described later.

The communication apparatus 15 is a communication interface that performs wireless communication, for example. The communication apparatus 15 communicates with the server 2 via the network 3, which as one example is the Internet. In more detail, the communication apparatus 15 is a TCU (Telematics Communication Unit). The communication apparatus 15 transmits data outputted from the update management ECU 11 via the network 3 to the server 2. The communication apparatus 15 also receives data (such as update data) transmitted from the server 2 via the network 3. The communication apparatus 15 transmits the data via a communication bus 16b to the update management ECU 11.

The server 2 is an apparatus installed outside the vehicle. As one example, the server 2 is a server including a control unit, a storage unit, and a communication unit (not illustrated). As examples, the storage unit of the server 2 stores programs or data for controlling each part of the vehicle-mounted system 1 (as examples, the update management ECU 11, the first ECU 12, the second ECU 13, and the third ECU 14). In an example configuration, manufacturers of the first ECU 12, the second ECU 13, and the third ECU 14 update programs or data as necessary and whenever this happens, store updated programs or data in the storage unit of the server 2. The control unit of the server 2 uses a communication unit to transmit the updated programs or data to the update management ECU 11 as update data.

The communication buses 16a and 16b are a vehicle-mounted communication network that is connected to the update management ECU 11. The communication buses 16a and 16b that extend from the update management ECU 11 are connected to various devices (such as the first ECU 12, the second ECU 13, the third ECU 14, and the communication apparatus 15). Although the two communication buses 16a and 16b extend from the update management ECU 11 in the example illustrated in FIG. 1, there is no particular limit on the number of communication buses. As one example, the communication buses 16a and 16b are compliant with a communication protocol such as CAN (Controller Area Network), Ethernet (registered trademark), or FlexRay (registered trademark), but are not limited to such.

The update management ECU 11 is connected to the first ECU 12, the second ECU 13, and the third ECU 14 via the communication bus 16a. In the example in FIG. 1, the update management ECU 11 is connected to the first ECU 12, the second ECU 13, and the third ECU 14 via the communication bus 16a.

Provided that the number of ECUs included in the vehicle-mounted system 1 is at least two, there is no particular limit on the number. ECUs are devices (or “operation-type ECUs”) that control various parts of the vehicle, such as a braking system, doors, a battery, and an air conditioner. There are no particular limitations on the functions of an ECU, and an ECU may be a device (or “recognition-type ECU”) that communicates with a sensor to monitor the state of part of the vehicle. The plurality of ECUs may have respectively different functions or may have the same functions.

The first ECU 12 is an ECU that operates in the +B state and the IG state. The internal configuration of the first ECU 12 is described later. Note that an ECU that operates in both the +B state and the IG state may be referred to as a “+B driven ECU”.

The second ECU 13 is an ECU that does not operate in the +B state but operates in the IG state. The internal configuration of the second ECU 13 will be described later. Note that an ECU that does not operate in the +B state but operates in the IG state may be referred to as an “IG driven ECU”.

The third ECU 14 is an ECU that was not originally connected but has subsequently been connected to the update management ECU 11. The internal configuration of the third ECU 14 will be described later.

### Internal Configuration of Update Management ECU 11

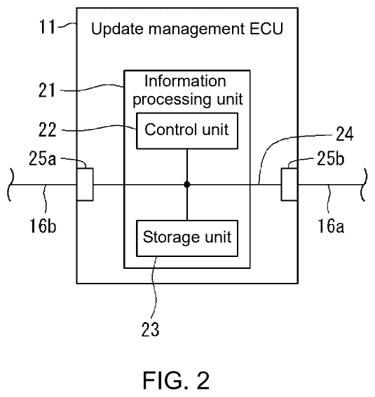

FIG. 2 is a diagram depicting one example of the internal configuration of the update management ECU 11.

The update management ECU 11 includes an information processing unit 21 including a control unit 22 and a storage unit 23, and a plurality of transceivers 25a and 25b. These units are electrically connected by an internal bus 24.

Although one example of the control unit 22 includes one or a plurality of central processing units (CPUs), the control unit 22 is not limited to this. When configured of CPUs, the control unit 22 executes various computation and control by reading out a computer program stored in the storage unit 23.

The storage unit 23 includes a volatile memory and a non-volatile memory, and stores various data. The volatile memory includes RAM (Random Access Memory), for example. Examples of non-volatile memory include flash memory, a hard disk drive (HDD), a solid state drive (SSD), and read-only memory (ROM). Part of the non-volatile memory may be provided outside the update management ECU 11.

As one example, the storage unit 23 stores computer programs, various parameters, and tables in the non-volatile memory. Note that as one example, the storage unit 23 stores computer programs, various parameters, and tables that are downloaded from the server 2 via the network 3 and the communication apparatus 15.

The plurality of transceivers 25a and 25b transmit and receive signals that flow on the communication buses 16a and 16b via ports, not illustrated. The transceivers 25a and 25b transmit information contained in the received signals via the internal bus 24 to the control unit 22. The transceivers 25a and 25b receive information sent by the control unit 22 via the internal bus 24 and transmit the information to the communication buses 16a and 16b. The transceiver 25a is connected to the communication bus 16b, and the transceiver 25b is connected to the communication bus 16a.

Note that although an example where the control unit 22 of the information processing unit 21 includes a CPU is described above, the control unit 22 is not limited to this. As examples, the information processing unit 21 may be an FPGA (Field Programmable Gate Array), an ASIC (Application Specific Integrated Circuit), or the like. In the case of an FPGA, the information processing unit 21 executes various computation and control according to a configuration that has been programmed in advance. In the case of an ASIC, the information processing unit 21 executes various computation and control according to a configuration that is internally configured during manufacturing.

### Internal Configuration of ECU

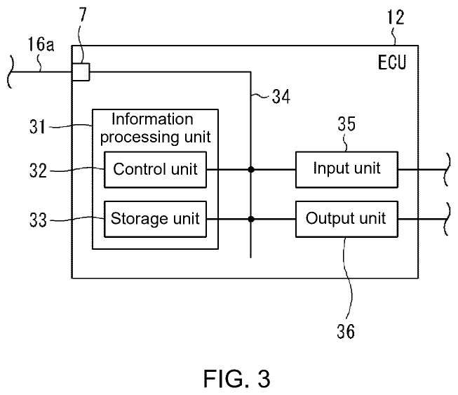

FIG. 3 is a diagram depicting one example of the internal configuration of the first ECU 12. The internal configurations of the second ECU 13 and the third ECU 14 are similar to that of the first ECU 12, and will therefore not be described.

The first ECU 12 includes an information processing unit 31, which includes a control unit 32 and a storage unit 33, a transceiver 37, an input unit 35, and an output unit 36. The transceiver 37 is electrically connected via an internal bus 34 to the information processing unit 31.

As one example, the control unit 32 reads out a computer program stored in the storage unit 33 and executes various computation and control.

Like the storage unit 23, the storage unit 33 includes a volatile memory and a non-volatile memory and stores various data. As examples, the storage unit 33 stores computer programs, various parameters, and tables in the non-volatile memory.

As one example, the transceiver 37 is an integrated circuit (IC), such as a CAN transceiver. The transceiver 37 is connected to the communication bus 16a and receives various control messages from the communication bus 16a.

The transceiver 37 includes a transmitter circuit and a receiver circuit (not illustrated). The transmitter circuit and the receiver circuit perform communication in conformity with the communication protocol of the communication bus 16a. The transmitter circuit converts data of a digital signal outputted by the information processing unit 31 into a predetermined analog signal and sends the analog signal to the communication bus 16a. The receiver circuit converts an analog signal inputted from the communication bus 16a into a digital signal that can be read by the information processing unit 31 and outputs the digital signal to the information processing unit 31.

As one example, the input unit 35 is connected to a sensor, an input device, and the like. The input unit 35 receives signals corresponding to the state of the vehicle and signals corresponding to instructions from the driver or the like. As examples, the sensors are a temperature sensor that detects the temperature inside the vehicle and door switches that detect whether the doors are closed. As one example, the input device is a switch or the like for operating an air conditioner.

As examples, the output unit 36 is connected to a motor or a solenoid. The output unit 36 drives the motor, solenoid, or the like that has been connected based on information sent by the information processing unit 31. As one example, this information is information indicating the operation of a motor or the like that has been connected. As one example, this motor is a motor that raises and lowers a door window. The solenoid is a solenoid that locks a door, for example.

### Problem to be Solved by Present Embodiment

When ECUs whose software has been updated and ECUs whose software has not been updated have both been present, there has been the risk of a discrepancy occurring in the communication between such ECUs. For this reason, the updating of software has been performed in a power supplying state in which every ECU is operating, such as the IG state. With this configuration, the updating of software will commence when the driver of the vehicle places the key switch that starts the engine in the ignition position, resulting in the risk of an increase in the time taken before the vehicle can be driven. Since updating is carried out in a power supplying state where every ECU is operating regardless of whether an update is necessary or unnecessary for the software of each individual ECU, power will also be supplied to ECUs whose software does not need to be updated, which risks an increase in power consumption.

Also for example, when a software update is performed for ECUs in the IG state, the timing at which the updating of software is completed at each ECU may differ from one ECU to another. If an ECU is activated immediately after the software has been updated, there is a risk that a function realized by a plurality of ECUs operating in cooperation will not be executed. As one example, if an ECU whose activation is complete has sent an instruction to an ECU that is yet to be activated, the ECU that is yet to be activated will not understand the instruction, resulting in the risk of the function in question not being executed.

As one example, in the case of a power window controlling function for rainy weather, a door ECU that controls power windows, a rain sensor ECU that detects raindrops, and a BCM (Body Control Module) that acquires information from the rain sensor ECU and transmits control to close the windows to the door ECU work in cooperation to execute the power window controlling function for rainy weather. As one example, when the rain sensitivity of a rain sensor improves compared to the past, a rainfall standard for closing the power windows changes, and a program is updated, it is possible to imagine a situation where the software of the rain sensor ECU is updated but the software of the BCM is not updated. In this situation, there has been a risk of a discrepancy occurring, such as a door window being left open even though it is raining.

A detailed example of a control content in the vehicle-mounted system 1 will now be described with reference to FIG. 1 to FIG. 6 as appropriate.

### Functions of Update Management Apparatus

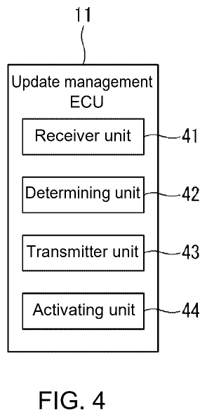

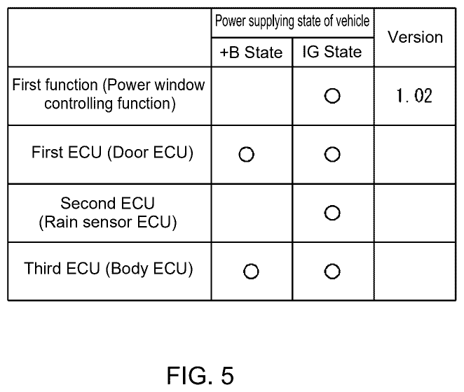

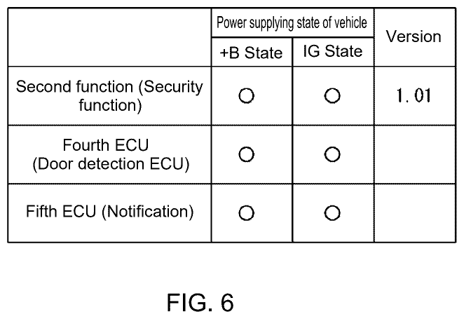

FIG. 4 is a functional block diagram depicting the functions included in the update management ECU 11. FIGS. 5 and 6 are tables depicting examples of ECU tables in which ECUs are listed. The update management ECU 11 includes four functional blocks, that is, a receiver unit 41, a determining unit 42, a transmitter unit 43, and an activating unit 44.

### Receiver Unit

The receiver unit 41 receives, from an external apparatus outside the vehicle, first update data for updating software of a first vehicle-mounted apparatus that operates in a first power supplying state and a second power supplying state that differs from the first power supplying state, and second update data for updating software of a second vehicle-mounted apparatus that does not operate in the first power supplying state but operates in the second power supplying state.

In more detail, the receiver unit 41 has a function of downloading the first update data and the second data from the server 2. The server 2 is provided at a data center of a vehicle manufacturer, for example. As one example, the server 2 stores update data for each ECU. The first update data is update data for updating the software of the first ECU 12, which is a +B driven ECU. The second update data is update data for updating the software of the second ECU 13, which is an IG driven ECU.

The receiver unit 41 operates the control unit 22 to access the server 2 via the internal bus 24, the transceiver 25a, the communication apparatus 15, and the network 3, and downloads the update data stored in the server 2. The trigger for downloading to start may be update data being newly recorded on the server 2, for example. In this case, the server transmits information indicating that new update data has been recorded to each vehicle-mounted system 1. This information indicating that new update data has been recorded may include information indicating the version of the update data that has been newly recorded. Hereinafter, information indicating that update data has been newly recorded is referred to as “updated software information”. One conceivable example of update data that has been newly recorded in the server 2 is an upgrade of a program for improving rainfall sensitivity compared to older rain sensors and changing the rainfall standard for closing power windows.

As one example, the update management ECU 11 of each vehicle-mounted system 1 stores an ECU table like that depicted in FIG. 5 in the storage unit 23. As one example, the ECU table includes information indicating a predetermined function, the ECUs that execute such predetermined function, the power supplying state in which such ECUs operate, and the software versions of the ECUs, and is recorded in the storage unit 23 in tabular form for each predetermined function. One example of a predetermined function is a power window controlling function for rainy weather. As examples, the ECUs that execute this function are a door ECU that controls power windows, a rain sensor ECU that detects raindrops, and the BCM that obtains information from the rain sensor ECU and transmits control to close the windows to the door ECU. As examples, the power supplying state in which the ECUs operate is the +B state for the door ECU and the BCM but is the IG state for the rain sensor ECU. The software version of the ECUs is 1.02, for example. In this example, since both +B driven ECUs and an IG driven ECU are included, this function as a whole operates in the IG state without operating in the +B state.

Note that although an example where the ECU table is stored in the storage unit 23 of the update management ECU 11 is described above, the present disclosure is not limited to this and the ECU table may be stored in the storage unit of the server 2, for example.

FIG. 6 is another example of an ECU table. In this example, the predetermined function is a security function. As one example, the ECUs that execute this predetermined function are a door detection ECU that detects whether the doors are closed and whether the doors are locked and a notification ECU that issues a warning to the driver. As one example, the power supplying state in which the ECUs operate is the +B state for both the door detection ECU and the notification ECU. The software version of the ECUs is 1.01, for example. In this example, since every ECU is a +B driven ECU, the function as a whole operates in the +B state and the IG state.

As one example, the receiver unit 41 compares the version information included in the updated software information sent from the server with the version information recorded in the ECU table, and determines whether the software has been updated. If it is determined that the software has been updated, the receiver unit 41 requests the update data from the server 2 and downloads the update data. As one example, the receiver unit 41 temporarily records the downloaded update data in the storage unit 23.

### Determining Unit

The determining unit 42 has a function of determining whether the power supplying state of the vehicle is the first power supplying state or the second power supplying state.

As a detailed example, the determining unit 42 detects the power supplying state of the vehicle and determines whether the detected power supplying state is the +B state or the IG state. This detection of the power supplying state of the vehicle may be performed by the update management ECU 11 or by a power supply monitoring ECU that monitors the power supplying state of the vehicle. One example of the detection of the power supplying state as the +B state is as follows. The voltage of a power supplying bus connected to an electrical device, such as the notification ECU, that is directly supplied with power from the vehicle battery is detected, and if the voltage is equal to or higher than a predetermined voltage, the power supplying state is determined to be the +B state. In the IG state, as one example, the voltage of a power supplying bus that supplies power to an ECU, such as an engine control ECU, that operates when the accelerator is pressed and the vehicle starts moving is detected, and if the voltage is equal to or higher than a predetermined voltage, the power supplying state is determined to be the IG state. Note that when the state is both the +B state and the IG state, the power supplying state is determined to be the IG state.

### Transmitter Unit

The transmitter unit 43 has a function of transmitting the first update data to the first vehicle-mounted apparatus when the determining unit has determined that the power supplying state of the vehicle is the first power supplying state, and of transmitting the second update data to the second vehicle-mounted apparatus when the determining unit has determined that the power supplying state of the vehicle is the second power supplying state.

In more detail, when the determining unit 42 has determined that the power supplying state of the vehicle is the +B state, the transmitter unit 43 transmits the first update data to the first ECU 12 (as examples, the door ECU and the BCM) that is a +B driven ECU. On the other hand, when the determining unit 42 has determined that the power supplying state of the vehicle is the IG state, the transmitter unit 43 transmits the second update data to the second ECU 13 (for example, the rain sensor ECU) that is an IG driven ECU.

When update data has been transmitted, the first ECU 12 and the second ECU 13 temporarily store the transmitted update data in the storage unit 33 for example. The control unit 32 of the ECU 12 may be configured so that after reception of the transmitted update data is complete, the software of the first ECU 12 is updated based on the update data temporarily stored in the storage unit 33.

### Activating Unit

The activating unit 44 has a function of activating, when the determining unit has determined that the power supplying state is the first state, software updated by the first update data at the first vehicle-mounted apparatus that executes a predetermined first function without the second vehicle-mounted apparatus and of activating, when the determining unit has determined that the power supplying state is the second state, software updated with the first update data and the second update data at the first vehicle-mounted apparatus and the second vehicle-mounted apparatus that execute a predetermined second function executed by the first vehicle-mounted apparatus and the second vehicle-mounted apparatus.

In more detail, for the example in FIG. 6, that is, a security function which as a whole is executed in the +B state, when the determining unit 42 has determined that the power supplying state is in the +B state, the activating unit 44 activates the software updated with the first update data at the door detection ECU and the notification ECU that operate in the +B state. In more detail, the activating unit 44 refers to the ECU table stored in the storage unit 23, as one example, a content like that depicted in FIG. 6. From the referenced ECU table, the activating unit 44 obtains information indicating the power supplying states in which the function in question operates. In the example in FIG. 6, since the security function operates in both the +B state and the IG state, when the power supplying state is the +B state, the activating unit 44 simultaneously transmits instructions to the door detection ECU and the notification ECU to instruct these ECUs to perform activation.

On the other hand, when the determining unit 42 has determined that the power supplying state is the IG state, the activating unit 44 activates the ECUs that execute functions that operate as a whole in the IG state. As one example, in the case of the power window controlling function for rainy weather, the activating unit 44 activates the updated software simultaneously at the door ECU, the BCM, and the rain sensor ECU. In more detail, the activating unit 44 refers to the ECU table (FIG. 5) and acquires information indicating that the power window controlling function for rainy weather as a whole operates in the IG state. When the determining unit 42 has determined that the power supplying state is the IG state, based on the acquired information, the activating unit 44 simultaneously transmits instructions to the door ECU, the BCM, and the rain sensor ECU to instruct these ECUs to perform activation.

### Control Method

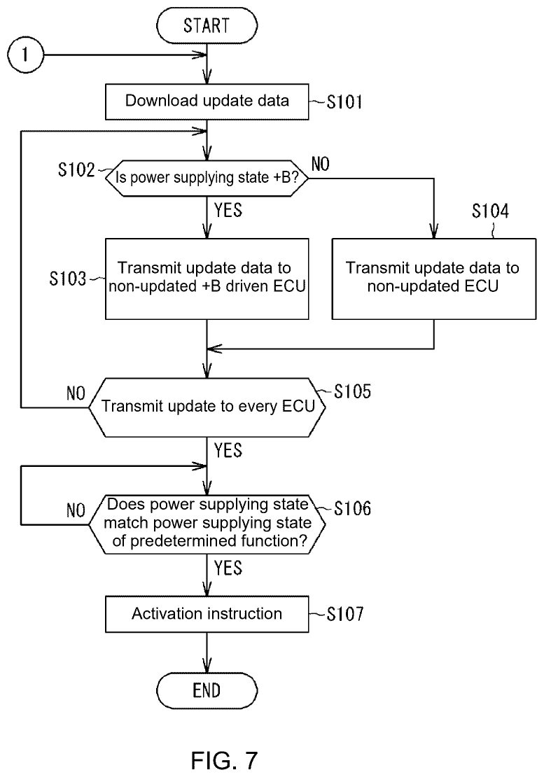

FIG. 7 is a flowchart depicting one example of a control method executed by the update management ECU 11. The order of the steps depicted in FIG. 7 may be changed as appropriate. A series of control processes will now be described with reference to FIG. 7.

Note that the control executed by the update management ECU 11 is executed by the information processing unit 21. When the information processing unit 21 executes such control, the control unit 22 reads a computer program from the storage unit 23 and executes various computation and processing.

The control executed by the first ECU 12 is executed by the information processing unit 31. When the information processing unit 31 executes such control, the control unit 32 reads a computer program from the storage unit 33 and executes various computation and processing.

First, the receiver unit 41 of the update management ECU 11 downloads the update data from the server 2 (step S101). In more detail, the update management ECU 11 receives, from an external apparatus outside the vehicle, the first update data for updating the software of a first vehicle-mounted apparatus that operates in a first power supplying state and a second power supplying state that differs from the first power supplying state, and second update data for updating the software of a second vehicle-mounted apparatus that does not operate in the first power supplying state but operates in the second power supplying state. After reception of the data is complete, the processing proceeds to step S102.

In more detail, the receiver unit 41 of the update management ECU 11 downloads the first update data and the second update data from the server 2. Update data for each ECU is stored in the server 2. The first update data is update data for updating the software of the first ECU 12 which is a +B driven ECU. The second update data is update data for updating the software of the second ECU 13, which is an IG driven ECU. The update management ECU 11 accesses the server 2 via the communication bus 16b, the transceiver 25a, the communication apparatus 15, and the network 3, and downloads the update data stored in the server 2.

As one example, when update data has been newly recorded in the server 2, the server 2 transmits updated software information to each vehicle-mounted system 1. This updated software information may include information indicating the version of the update data that has been newly recorded.

As one example, the update management ECU 11 of each vehicle-mounted system 1 stores an ECU table like that depicted in FIG. 5 in the storage unit 23. In such ECU table, information indicating a predetermined function, ECUs that execute such predetermined function, a power supplying state in which each ECU operates, and software versions of the ECUs is recorded in tabular form for each predetermined function.

As one example, the receiver unit 41 of the update management ECU 11 compares the updated software information (including information indicating the version) sent from the server with the ECU tables recorded in the storage unit 23, and determines whether the software has been updated. As one example, the versions of software are compared to determine whether the software has been updated. When it has been determined that software has been updated, the receiver unit 41 requests the update data from the server 2 and downloads the update data. As one example, the receiver unit 41 temporarily records the downloaded update data in the storage unit 23. After such downloading has been complete, the processing proceeds to step S102.

Next, the determining unit 42 of the update management ECU 11 determines whether the power supplying state of the vehicle is the first power supplying state or the second power supplying state (step S102).

In more detail, the determining unit 42 of the update management ECU 11 detects, for example, the power supplying state of the vehicle and determines whether the detected power supplying state is the +B state. When the determining unit 42 of the update management ECU 11 has determined that the power supplying state is the +B state (YES in step S102), the processing proceeds to step S103, and when the determining unit 42 has determined that the power supplying state is not the +B state, that is, in the IG state (NO in step S102), the processing proceeds to step S104.

Next, when it has been determined that the power supplying state of the vehicle is the first power supplying state (YES in step S102), the transmitter unit 43 of the update management ECU 11 transmits the first update data to the first vehicle-mounted apparatus (step S103). After transmission is complete, the processing proceeds to step S105. In more detail, when for example the determining unit 42 has determined that the power supplying state of the vehicle is the +B state, the transmitter unit 43 of the update management ECU 11 transmits the first update data to the first ECU 12, which is a +B driven ECU that has not been updated. As one example, it is determined whether the ECU software has been updated by recording whether the software has been updated in an ECU table. Based on the ECU tables stored in the storage unit 23, the transmitter unit 43 of the update management ECU 11 may transmit update data to the +B driven ECU stored in the ECU table. In the example in FIG. 5, update data is transmitted to the door ECU and the BCM.

On the other hand, when the determining unit has determined that the power supplying state of the vehicle is the second power supplying state (NO in step S102), the second update data is transmitted to the second vehicle-mounted apparatus (step S104). After this transmission is complete, the processing proceeds to step S105. As a more detailed example, when the determining unit 42 has determined that the power supplying state of the vehicle is the IG state, the transmitter unit 43 of the update management ECU 11 transmits the second update data to the second ECU 13, which is an IG driven ECU that has not been updated. Based on an ECU table stored in the storage unit 23, the transmitter unit 43 of the update management ECU 11 may transmit the update data to the IG driven ECUs stored in the ECU table. In the example in FIG. 5, the update data is transmitted to the rain sensor ECU.

Note that even when the determining unit 42 has determined that the vehicle is in the IG state, if there is a +B driven ECU that is yet to be updated, the transmitter unit 43 may send the first update data to the ECU in question. This is because although there can be cases where power supplying state changes from the +B state to the IG state while the first update data is being sent to a +B driven ECU that is yet to be updated, each +B driven ECU will still operate even if the power supplying state is in the IG state. Accordingly, in step S104, the transmitter unit 43 transmits update data to ECUs that have not been updated, regardless of whether such ECUs are +B driven ECUs or IG driven ECUs.

When update data has been transmitted to the first ECU 12 (here, the door ECU and the BCM) and the second ECU 13 (here, the rain sensor ECU), the ECUs may temporarily store the transmitted update data in the storage unit 33, for example. After the transmitted update data has been received, the control unit 32 may update the software based on the update data temporarily stored in the storage unit 33.

Next, the transmitter unit 43 of the update management ECU 11 determines whether the update data has been transmitted to all of the ECUs that execute a predetermined function (step S105). As a specific example, the transmitter unit 43 of the update management ECU 11 refers to the ECU table stored in the storage unit 23 and determines whether the update data has been transmitted to every ECU stored in the ECU table. When the transmitter unit 43 has determined that the update data has been transmitted to every ECU, the processing proceeds to step S106, but when the transmitter unit 43 has determined that the update data has not been transmitted to every ECU, the processing returns to step S102. Accordingly, steps S102 to S104 are repeated until the transmitter unit 43 has transmitted update data to every ECU. In the example depicted in FIG. 5, since the power window controlling function for rainy weather is executed by the door ECU, the rain sensor ECU, and the BCM, it is determined whether update data has been transmitted to all three ECUs, that is, the door ECU, the rain sensor ECU, and the BCM.

Next, the activating unit 44 of the update management ECU 11 determines whether the power supplying state of the vehicle is a power supplying state in which a predetermined function operates (step S106). When the activating unit 44 of the update management ECU 11 has determined that the power supplying state of the vehicle is a power supplying state in which the ECUs that execute the predetermined function operate, the processing proceeds to step S107, and when the activating unit 44 has determined that the power supplying state is not a power supplying state in which the ECUs that execute the predetermined function operate, the processing returns to step S106. Accordingly, the activating unit 44 of the update management ECU 11 waits until the power supplying state of the vehicle becomes the power supplying state in which the predetermined function operates.

As another example, the security function described earlier is executed by the door detection ECU that detects whether the doors are closed and whether the doors are locked, and the notification ECU that issues a warning to the driver. Since the door detection ECU and the notification ECU are both +B driven ECUs, the security function as a whole operates in the +B state and the IG state. In this example, after the update data is transmitted to the ECUs, the update management ECU 11 proceeds to step S107 when it is determined that the power supplying state is the +B state.

On the other hand, the power window controlling function for rainy weather described earlier is executed by the door ECU, the rain sensor ECU, and the BCM. Since the door ECU and the BCM are +B driven ECUs, but the rain sensor ECU is an IG driven ECU, the power window controlling function as a whole operates in the IG state. For this reason, in this example, after the update data is transmitted to the ECUs, the activating unit 44 of the update management ECU 11 proceeds to step S107 when it is determined that the power supplying state is the IG state.

Next, the activating unit 44 of the update management ECU 11 activates the group of ECUs that execute the predetermined function (step S107). As a more detailed example, the activating unit 44 of the update management ECU 11 uses the control unit 22 to transmit an activation instruction to the first ECU 12 and/or the second ECU via the internal bus 24, the transceiver 25b, and the communication bus 16a. Each ECU that has received the activation instruction activates the software that has been updated using the update data. As one example, in the case of the security function described earlier, an instruction to perform activation is transmitted to the door detection ECU and the notification ECU. In the case of the power window controlling function for rainy weather described earlier, an instruction to perform activation is transmitted to the door ECU, the rain sensor ECU, and the BCM.

After this instruction to perform activation has been transmitted, this series of control processes ends.

### Control Sequence

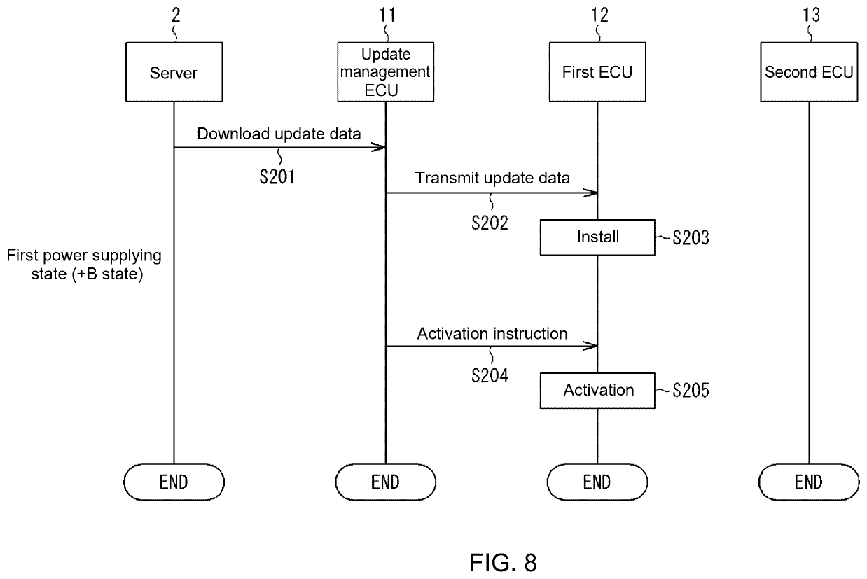

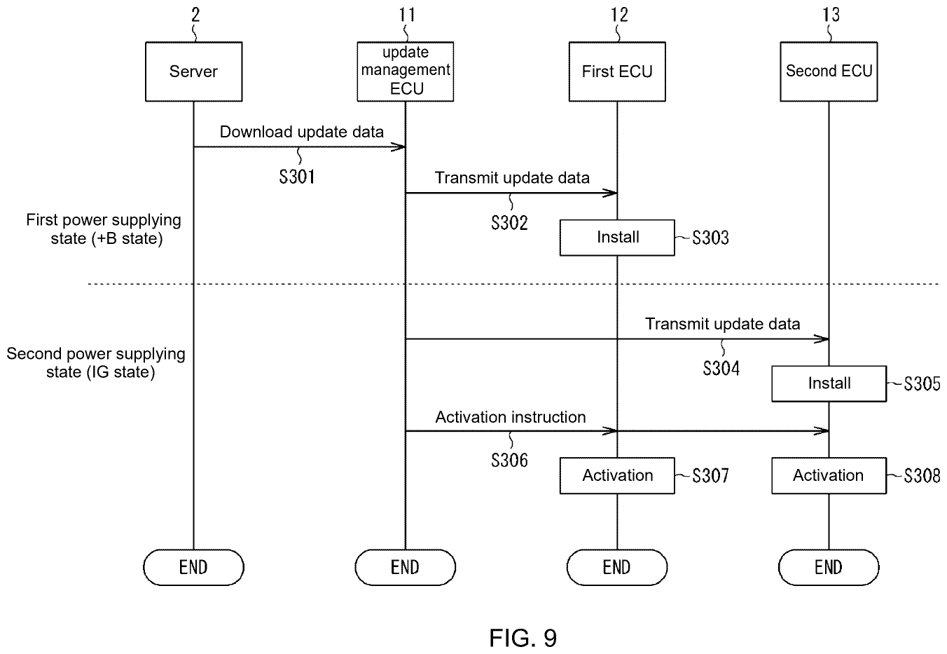

Next, a control sequence in the vehicle-mounted system 1 will be described. FIG. 8 is a sequence diagram for when a predetermined function is executed by +B driven ECUs. FIG. 9 is a sequence diagram for when a predetermined function is executed by +B driven ECUs and IG driven ECUs.

### Execution by +B Driven ECUs

One example of a predetermined function executed by +B driven ECUs is the security function described earlier.

First, the receiver unit 41 of the update management ECU 11 downloads the update data from the server 2 (step S201). Note that since only update data is downloaded, it is sufficient for at least the update management ECU 11 to operate. Since the update management ECU 11 can operate in the +B state and in the IG state, this step S201 will be executed if the power supplying state is at least the +B state.

Next, the transmitter unit 43 of the update management ECU 11 transmits the update data from the update management ECU 11 to the first ECU 12 (step S202). For the example of the security function described earlier, the transmitter unit 43 transmits the update data to the door detection ECU and the notification ECU.

After this, the first ECU 12 updates the software of that ECU based on the update data (step S203). As one example, the first ECU 12 is configured to update the software based on the update data after reception of the update data is complete.

Next, the activating unit 44 of the update management ECU 11 transmits an activation instruction to the first ECU (step S204).

After this, the group of first ECUs 12 that execute the predetermined function and have received an instruction perform activation activate the updated software (step S205). After activation is complete, this series of control processes ends.

### Execution by +B Driven ECUs and IG Driven ECUs

One example of a predetermined function executed by +B driven ECUs and IG driven ECUs is the power window controlling function described earlier.

First, the receiver unit 41 of the update management ECU 11 downloads the update data from the server 2 (step S301).

Next, the transmitter unit 43 of the update management ECU 11 transmits the update data to the first ECU 12 (step S302). For the example of the power window controlling function described earlier, since the door ECU and the BCM are +B driven ECUs but the rain sensor ECU is an IG driven ECU, in this step, update data is transmitted to the door ECU and the BCM.

After this, the first ECU 12 updates the software of that ECU based on the update data (step S303).

Next, when the power supplying state has switched from the +B state to the IG state, that is, when it has been determined that the power supplying state of the determining unit 42 of the update management ECU 11 is the IG state, the transmitter unit 43 of the update management ECU 11 transmits update data to the update management ECU 11. In the case of the power window controlling function described earlier, the transmitter unit 43 transmits the update data to the rain sensor ECU that is an IG driven ECU (step S304).

After this, the second ECU 13 updates the software of that ECU based on the update data (step S305). As one example, the second ECU 13 is configured to update the software based on the update data after reception of the update data is complete.

Next, the activating unit 44 of the update management ECU 11 transmits an instruction for performing activation to the first ECU 12 and the second ECU 13 (step S306).

After this, the group of first ECUs 12 and the second ECUs 13 that execute the predetermined function activate the updated software (step S307 and step S308). After activation is complete, this control procedure ends.

### Overview

When ECUs whose software has been updated and ECUs whose software has not been updated coexist, there has been the risk of a discrepancy in communication between such ECUs. For this reason, software updates have been performed in a power supplying state, such as the IG state, in which every ECU operates. With such a configuration, the updating of software begins when the driver of the vehicle has placed the key switch that starts the engine in the ignition position, which carries the risk that it will take longer before the vehicle becomes drivable. Since updating is performed in a power supplying state in which every ECU is operating regardless of whether it is necessary or unnecessary to update their software, power is supplied even to ECUs whose software does not need to be updated, which risks an increase in power consumption.

The present embodiment is configured so that in keeping with the power supplying state of the vehicle, the update management ECU 11 transmits update data to ECUs whose software can be updated in that power supplying state to have such ECUs update their software. In the example described earlier, the update management ECU 11 transmits update data to the +B driven ECUs, that is, the door ECU, the BCM, the door detection ECU, and the notification ECU, when the power supplying state is in the +B state without waiting for the power supplying state to become the IG state. In the +B state, each +B driven ECU can update its software based on update data. Accordingly, when the driver of the vehicle places the key switch that starts the engine in the ignition position, that is, when the power supplying state changes from the +B state to the IG state, the updating of the software of such ECUs will have already completed. This means that the vehicle can be driven by simply waiting for the software of the IG driven ECUs, which operate only in the IG state, to be updated, which shortens the time taken until the vehicle can be driven. In addition, since the software of the +B driven ECUs is updated while the IG driven ECUs are not operating, power consumption can be reduced.

When the software of each ECU is updated, the timing at which the updating of software at individual ECUs is completed may differ from ECU to ECU. In cases where individual ECUs have been activated soon after their software has been updated, there has been the risk of functions where a plurality of ECUs operate in cooperation not being executed. As one example, when an ECU that has completed activation sends an instruction to an ECU that is yet to be activated, the ECU that is yet to finish activation is not able to understand the instruction, resulting in risk of the function in question not being executed.

According to the present embodiment, for a group of vehicle-mounted apparatuses that execute a predetermined function, the update management ECU 11 activates updated software simultaneously in a power supplying state in which such function operates. As one example, the power window controlling function for rainy weather described earlier is executed by the door ECU, the rain sensor ECU, and the BCM. Since the door ECU and the BCM are +B driven ECUs and the rain sensor ECU is an IG driven ECU, the function as a whole operates in the IG state and the update management ECU 11 activates such ECUs simultaneously when the power supplying state is the IG state. Accordingly, the ECUs can communicate with no discrepancy, so that the door window will be closed when there is an appropriate amount of rain, which eliminates the risk of a discrepancy occurring, such as a door window remaining open even when it is raining.

### Second Embodiment

A second embodiment of the present disclosure will now be described in detail with reference to the accompanying drawings.

The first and second embodiments differ in that the update management apparatus performs a software update for an ECU that has been newly added at a later date, but are otherwise the same. Components that are the same as those in the first embodiment have been assigned the same reference numerals, and descriptions of the same components, functions, and operations is omitted. One example of an ECU that is subsequently newly added is when a seat heater is subsequently added to a completed vehicle that was not equipped with a seat heater, and a seat ECU for controlling the seat heater is also added.

### Problem to be Solved by Present Embodiment

In the past, when a new system that involves the addition of an ECU was newly installed in a vehicle, there was no function for updating the software of such retrofitted ECU, creating the risk that the software of the retrofitted ECU would not be updated and a predetermined function will not be performed, resulting in discrepancies such as the seat heater not heating up.

### Means to Solve the Problem of Present Embodiment

For this reason, in the present embodiment, the update management apparatus is configured so that when a third vehicle-mounted apparatus has been newly connected to the update management apparatus to which the first vehicle-mounted apparatus and the second vehicle-mounted apparatus are connected, the receiver unit receives third update data for updating software of the third vehicle-mounted apparatus from an external apparatus outside the vehicle, the transmitter unit transmits, when the third vehicle-mounted apparatus operates in the first power supplying state and the second power supplying state and the determining unit has determined that the power supplying state of the vehicle is the first power supplying state, the third update data to the third vehicle-mounted apparatus, and the transmitter unit transmits, when the third vehicle-mounted apparatus does not operate in the first power supplying state but operates in the second power supplying state and the determining unit has determined that the power supplying state of the vehicle is the second power supplying state, the third update data to the third vehicle-mounted apparatus.

In particular, in the present embodiment, the operation of the update management apparatus when a third vehicle-mounted apparatus has been newly connected to the update management apparatus to which the first vehicle-mounted apparatus and the second vehicle-mounted apparatus are connected differs from the operation in the first embodiment. The control method for this different part is described below.

### Control Method

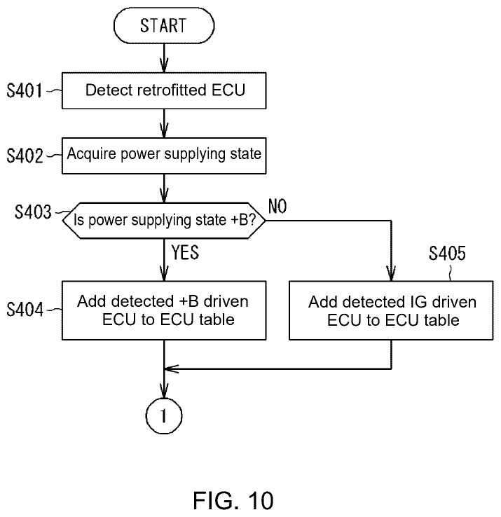

FIG. 10 is a flowchart of the operation of the update management ECU 11 when a new ECU has been added, as a part that is added to the flowchart in FIG. 7. Note that the newly connected third vehicle-mounted apparatus is the third ECU 14 in FIG. 1.

First, the update management ECU 11 detects a retrofitted ECU (step S401) and proceeds to step S402. As one example method of detecting a retrofitted ECU, it is detected whether communication has been established between the update management ECU 11 and the third ECU 14 that has been newly connected. Alternatively, the update management ECU 11 periodically broadcasts, on the communication bus 16a, an instruction requesting a response from every ECU connected to the communication bus 16a. The update management ECU 11 may compare the ECUs that have responded with an ECU table that is stored in the storage unit 23 and in which ECUs that are already connected are listed, and determine that a retrofitted ECU has been detected when there has been a response from an ECU that is not present in the ECU table.

Next, the update management ECU 11 acquires the power supplying state of the vehicle (step S402) and proceeds to step S403.

After this, the update management ECU 11 determines whether the power supplying state is the +B state (step S403). If it has been determined that the power supplying state is the +B state, the processing proceeds to step S404. On the other hand, if it has been determined that the power supplying state is not the +B state, that is, if it has been determined that the power supplying state is the IG state, the processing proceeds to step S405. Since the +B driven ECUs respond when the power supplying state is the +B state, and the IG driven ECUs respond when the power supplying state is the IG state, by knowing the power supplying state, the update management ECU 11 can determine whether an ECU that provided a new response in step S401 is a +B driven ECU or an IG driven ECU.

Next, if the update management ECU 11 has determined that the power supplying state is the +B state, the update management ECU 11 adds, when a predetermined function as a whole operates in the +B state for example, the ECU that was detected in step S401 to an ECU table in which ECUs that execute that function are listed (step S404).

On the other hand, if it has been determined that the power supplying state is not the +B state (that is, the IG state), the update management ECU 11 adds, when a predetermined function as a whole operates in the IG state for example, the ECU that was detected in step S401 to an ECU table in which the ECUs that execute that function are listed (step S405).

After the series of processes described above is complete, the update management ECU 11 proceeds to step S101 in FIG. 7 and the processing continues.

### Overview

In the past, when a new system that involves the addition of an ECU has been newly installed in a vehicle, there was no function to update the software of the retrofitted ECU. This resulted in the risk of the software of the retrofitted ECU not being updated, causing discrepancies where predetermined functions would not be executed.

According to the present disclosure, when a new third vehicle-mounted apparatus has been connected to an update management apparatus, third update data is transmitted to the third vehicle-mounted apparatus in a power supplying state in which the third vehicle-mounted apparatus can operate. By doing so, it is possible to update a newly added third vehicle-mounted apparatus at appropriate timing.

### APPENDIX

Note that the embodiment described above and the various modifications can be freely combined at least in part. The embodiments and modifications disclosed above are exemplary in all respects and should not be regarded as limitations on the present disclosure. The scope of the present disclosure is indicated by the range of the patent claims, not the description given above, and is intended to include all changes within the meaning and scope of the patent claims and their equivalents.

1. An update management apparatus for managing a software update of a vehicle-mounted apparatus in a vehicle with a plurality of power supplying states, the plurality of power supplying states including a first power supplying state and a second power supplying state that differs from the first power supplying state and the update management apparatus comprising:
a receiver unit configured to receive, from an external apparatus outside the vehicle, first update data for updating software of a first vehicle-mounted apparatus that operates in the first power supplying state and the second power supplying state, and second update data for updating software of a second vehicle-mounted apparatus that does not operate in the first power supplying state but operates in the second power supplying state;
a determining unit configured to determine whether a power supplying state of the vehicle is the first power supplying state or the second power supplying state; and
a transmitter unit configured to transmit the first update data to the first vehicle-mounted apparatus when the determining unit has determined that the power supplying state of the vehicle is the first power supplying state and transmitting the second update data to the second vehicle-mounted apparatus when the determining unit has determined that the power supplying state of the vehicle is the second power supplying state.

2. The update management apparatus according to claim 1, wherein the receiver unit receives the first update data and the second update data from the external apparatus while the power supplying state is the first power supplying state.

3. The update management apparatus according to claim 1,
further including an activating unit configured to activate, when the determining unit has determined that the power supplying state is the first state, software that was updated using the first update data at the first vehicle-mounted apparatus that executes a predetermined first function without the second vehicle-mounted apparatus, and activate, when the determining unit has determined that the power supplying state is the second state, software that was updated using the first update data and the second update data at the first vehicle-mounted apparatus and the second vehicle-mounted apparatus that execute a predetermined second function executed by the first vehicle-mounted apparatus and the second vehicle-mounted apparatus.

4. The update management apparatus according to claim 1,
wherein when a third vehicle-mounted apparatus has been newly connected to the update management apparatus to which the first vehicle-mounted apparatus and the second vehicle-mounted apparatus are connected, the receiver unit receives third update data for updating software of the third vehicle-mounted apparatus from an external apparatus outside the vehicle,
the transmitter unit transmits, when the third vehicle-mounted apparatus operates in the first power supplying state and the second power supplying state and the determining unit has determined that the power supplying state of the vehicle is the first power supplying state, the third update data to the third vehicle-mounted apparatus, and
the transmitter unit transmits, when the third vehicle-mounted apparatus does not operate in the first power supplying state but operates in the second power supplying state and the determining unit has determined that the power supplying state of the vehicle is the second power supplying state, the third update data to the third vehicle-mounted apparatus.

5. The update management apparatus according to claim 4, wherein the receiver unit receives the first update data, the second update data, and the third update data from the external apparatus while the power supplying state is the first power supplying state.

6. The update management apparatus according to claim 4,
wherein the activating unit activates, when the third vehicle-mounted apparatus operates in the first power supplying state and the second power supplying state and the determining unit has determined that the power supplying state is the first state, software that was updated using the third update data at the third vehicle-mounted apparatus that executes a predetermined third function with the first vehicle-mounted apparatus without the second vehicle-mounted apparatus, and activates software that was updated using the first update data at the first vehicle-mounted apparatus that executes the third function, and
activates, when the third vehicle-mounted apparatus does not operate in the first power supplying state but operates in the second power supplying state and the determining unit has determined that the power supplying state is the second state, software that was updated using the third update data at the third vehicle-mounted apparatus that executes a predetermined fourth function with the second vehicle-mounted apparatus, and activates software that was updated using the second update data at the second vehicle-mounted apparatus that executes the fourth function.

7. The update management apparatus according to claim 1, wherein the first power supplying state is a power supplying state when the vehicle is in a state where the vehicle is incapable of running, and the second power supplying state is a power supplying state when the vehicle is in a state where the vehicle is capable of running.

8. A vehicle-mounted system comprising:
the update management apparatus according to claim 1; and
the first vehicle-mounted apparatus, the second vehicle-mounted apparatus, or the third vehicle-mounted apparatus connected to the update management apparatus.

9. A control method of an update management apparatus that manages a software update of a vehicle-mounted apparatus in a vehicle with a plurality of power supplying states, the plurality of power supplying states including a first power supplying state and a second power supplying state that differs from the first power supplying state,
the control method comprising:
a step of receiving, from an external apparatus outside the vehicle, first update data for updating software of a first vehicle-mounted apparatus that operates in the first power supplying state and the second power supplying state, and second update data for updating software of a second vehicle-mounted apparatus that does not operate in the first power supplying state but operates in the second power supplying state;
a step of determining whether a power supplying state of the vehicle is the first power supplying state or the second power supplying state;
a first step of transmitting the first update data to the first vehicle-mounted apparatus when the step of determining has determined that the power supplying state of the vehicle is the first power supplying state; and
a second step of transmitting the second update data to the second vehicle-mounted apparatus when the step of determining has determined that the power supplying state of the vehicle is the second power supplying state.

10. A computer program for controlling an update management apparatus that manages a software update of a vehicle-mounted apparatus in a vehicle with a plurality of power supplying states, the plurality of power supplying states including a first power supplying state and a second power supplying state that differs from the first power supplying state,
the computer program comprising:
a step of receiving, from an external apparatus outside the vehicle, first update data for updating software of a first vehicle-mounted apparatus that operates in the first power supplying state and the second power supplying state, and second update data for updating software of a second vehicle-mounted apparatus that does not operate in the first power supplying state but operates in the second power supplying state;
a step of determining whether a power supplying state of the vehicle is the first power supplying state or the second power supplying state;
a first step of transmitting the first update data to the first vehicle-mounted apparatus when the step of determining has determined that the power supplying state of the vehicle is the first power supplying state; and
a second step of transmitting the second update data to the second vehicle-mounted apparatus when the step of determining has determined that the power supplying state of the vehicle is the second power supplying state.
